(19) United States
(12) Patent Application Publication
(10) Pub. No.: US 2003/0163312 A1
(43) Pub. Date: Aug. 28, 2003

(54) Speech processing apparatus and method

(75) Inventor: Andrea Sorrentino, Berkshire (GB)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/288,285

(22) Filed: Nov. 6, 2002

(30) Foreign Application Priority Data
Feb. 26, 2002 (GB) 0204477.4

(51) Int. Cl. G10L 15/14

(52) U.S. Cl. 704/256

(57) ABSTRACT

A speech recognition system is disclosed including a model generation unit (20) and a speech recognition unit (22). When signals are received from a microphone (7) the model generation unit (20) utilises the signals to generate hidden Markov models that are stored in a hidden Markov model database (24). Subsequently, when utterances are to be recognised, the speech recognition unit (22) utilises the stored hidden Markov models to associate an utterance with a word. When a new hidden Markov model is generated by the model generation unit (20) the new hidden Markov model is processed by a confusability checker (26) against the hidden Markov models already stored in the database (24). A value indicative of the likelihood of utterances corresponding to the new model being confused with previously stored models is determined by the confusability checker (26) directly from the parameters for the new hidden Markov model and the other hidden Markov models stored in the database (24). If this value indicates a high likelihood of words being confused, the new entry is deleted from the database (24) and a warning is output to the user.

The present invention relates to a speech processing apparatus and method. In particular, embodiments of the present invention are applicable to speech recognition.

Speech recognition is a process by which an unknown speech utterance is identified. There are several different types of speech recognition systems currently available which can be categorised in several ways. For example, some systems are speaker dependent, whereas others are speaker independent. Some systems operate for a large vocabulary of words (>10,000 words) while others only operate with a limited sized vocabulary (<1000 words). Some systems can only recognise isolated words whereas others can recognise phrases comprising a series of connected words.

In a limited vocabulary system, speech recognition is performed by comparing features of an unknown utterance with features of known words which are stored in a database. The features of the known words are determined during a training session in which one or more samples of the known words are used to generate reference patterns therefor. The reference patterns may be acoustic templates of the modelled speech or statistical models, such as Hidden Markov Models.

To recognise the unknown utterance, the speech recognition apparatus extracts a pattern (or features) from the utterance and compares it against each reference pattern stored in the database. A scoring technique is used to provide a measure of how well each reference pattern, or each combination of reference patterns, matches the pattern extracted from the input utterance. The unknown utterance is then recognised as the word(s) associated with the reference pattern(s) which most closely match the unknown utterance.

The vocabulary of a speech recognition system is the set of words that the system can recognise. In this context, a word can be either a single word or a short phrase. The accuracy of a speech recognition system is critically dependent upon the particular words its vocabulary is composed of. If the vocabulary contains many similar confusable words the accuracy of the system will be poor compared to the seeing system arranged to process a vocabulary of highly distinctive words.

When a vocabulary for a speaker independent system is created, if the vocabulary is small enough the system can be tested to generated a set of statistics accounting for the number of times each word has been confused with a different word. If the number of errors detected when testing the system is too high, the vocabulary can be adjusted so that the accuracy of the speech recognition system is increased. A problem with this approach is however that testing of vocabularies require considerable amounts of training data and therefore only small vocabularies can be tested in this way.

In a typical speaker dependent speech recognition system, the vocabulary is incrementally created by an end user. A typical example is the phonebook of a mobile phone where a user adds voice tags to phonebook entries in order to use the speech recognition system to recall the phone numbers. The generation of a vocabulary in this way is much less controlled in that it is quite possible for a user to enter confusable words. An extreme case occurs when the same word is entered as the voice tag for two different entries. However, as only a limited number of utterances are available, it is not possible to test the system to determine that this has occurred.

In U.S. Pat. No. 5,737,723 a phonetic speech recognition system is described in which the likelihood of confusion between two words is calculated by storing a lookup table of the probabilities individual phonemes will be misrecognised. When the new word is entered into the system, it is converted into a phonetic representation of the word. The probability of this phonetic representation being mistaken as the phonetic representation for another word in the vocabulary is then calculated using the look-up table. Although the system of U.S. Pat. No. 5,737,723 enables confusability statistics to be generated for phonetic based speech recognition systems, the system is unsuitable for identifying words which may be confused in other speech recognition systems such as those based on Hidden Markov Models.

It is therefore desirable to provide an alternative method for identifying confusable words. In particular it is desirable to provide a system where the confusability of words may be identified without needing to store large amounts of training data.

In accordance with one aspect of the present invention, there is provided a method of processing Hidden Markov Models to generate values indicative of the probability of patterns comprising a series of signals corresponding to one Hidden Markov Model being identified as corresponding to a second Hidden Markov Model, the method comprising the steps of:

storing data for a first and a second Hidden Markov Model, said data comprising for each model a probability density function associated with each of a number of states;

processing said stored probability density functions associated with states from said first Hidden Markov Model with probability density functions from states from said second Hidden Markov Model to determine a value indicative of the probability of a signal associated with said state of said first Hidden Markov Model being identified as associated with said state of said second Hidden Markov Model;

determining for series of states associated with allowable transitions for said first and said second Hidden Markov Models, the sums of said values determined for pairs of states in said series and outputting as a value indicative of the confusability of said first and said second Hidden Markov Models a calculated sum of said values for said pairs of states associated with allowable transitions divided by the number of transitions.

An exemplary embodiment of the invention will now be described with reference to the accompanying drawings in which:

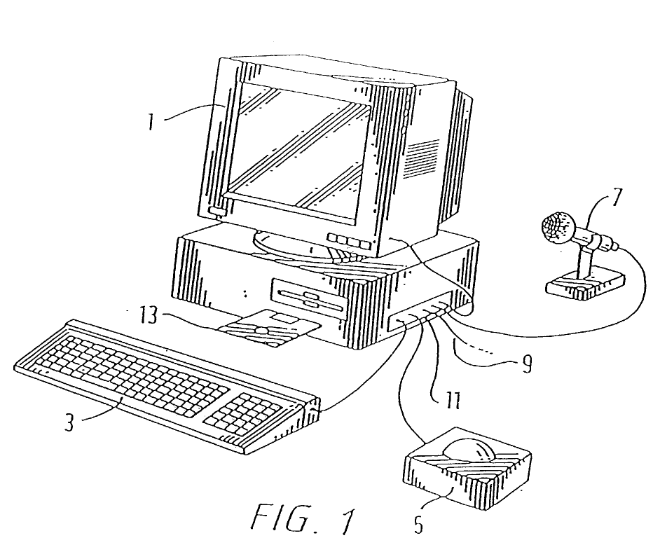

FIG. 1 is a schematic view of a computer which may be programmed to operate an embodiment of the present invention;

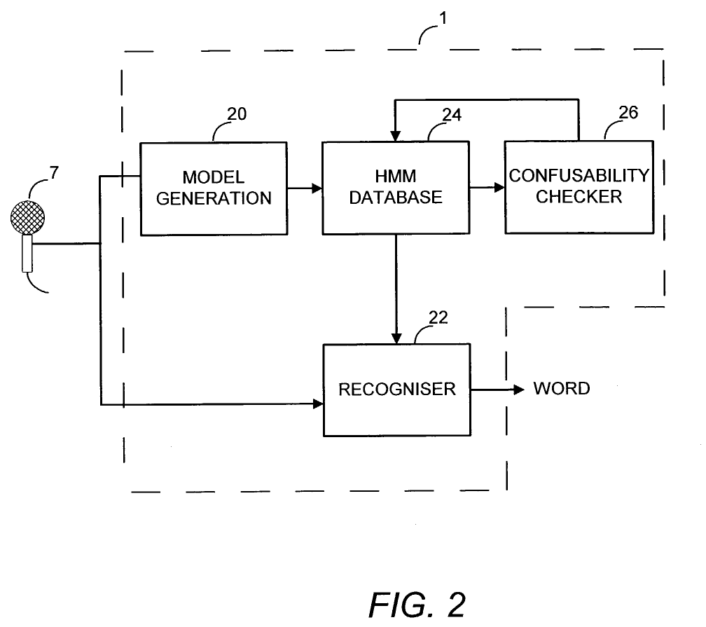

FIG. 2 is a schematic block diagram of a speech recognition system in accordance with an embodiment of the present invention;

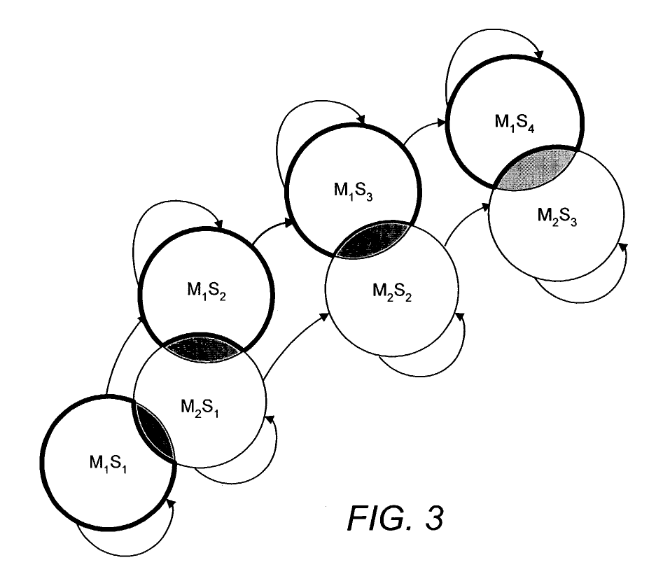

FIG. 3 is a schematic illustration of a pair of Hidden Markov Models;

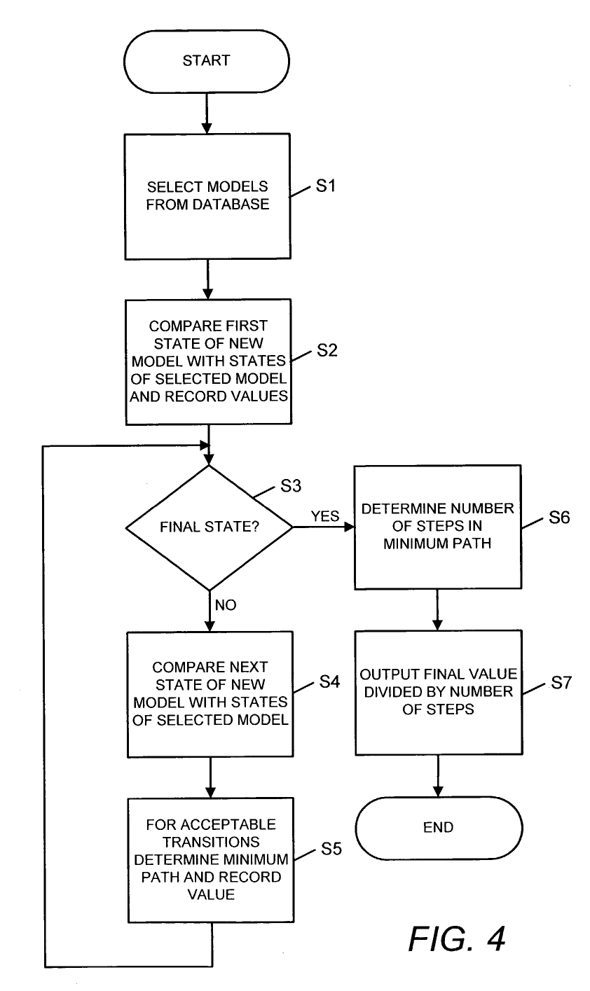

FIG. 4 is a flow diagram of the processing of the confusability checker of the speech recognition system of FIG. 2; and

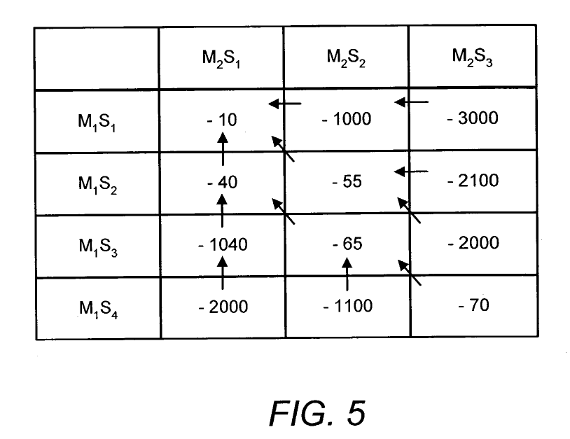

FIG. 5 is an exemplary table illustrating the calculation of the confusability value for a pair of Hidden Markov Models.

Embodiments of the present invention can be implemented in computer hardware, but the embodiment to be described is implemented in software which is run in conjunction with processing hardware such as a personal computer, workstation, photocopier, facsimile machine, personal digital assistant (PDA) or the like.

FIG. 1 shows a personal computer (PC) 1 which may be programmed to operate an embodiment of the present invention. A keyboard 3, a pointing device 5, a microphone 7 and a telephone line 9 are connected to the PC 1 via an interface 11. The keyboard 3 and pointing device 5 enable the system to be controlled by a user. The microphone 7 converts the acoustic speech signal of the user into an equivalent electrical signal and supplies this to the PC 1 for processing. An internal modem and speech receiving circuit (not shown) may be connected to the telephone line 9 so that the PC 1 can communicate with, for example, a remote computer or with a remote user.

The program instructions which make the PC 1 operate in accordance with the present invention may be supplied for use with an existing PC 1 on, for example a storage device such as a magnetic disc 13, or by downloading the software from the Internet (not shown) via the internal modem and the telephone line 9.

The operation of the speech recognition system of this embodiment will now be briefly described with reference to FIG. 2.

The program instructions which make the PC 1 operate in accordance with the present invention cause the PC 1 to become configured into a number of notional functional units. These notional functional units are illustrated in FIG. 2. The notional function units described in this embodiment are illustrative only and need not represent exact portions of program or memory in an embodiment of the present invention.

Electrical signals representative of input speech from, for example, the microphone 7 are applied to a model generation unit 20 and to a speech recognition unit 22. The model generation unit 20 and the speech recognition unit 22 are connected to one another via a Hidden Markov Model database 24. When the PC 1 is being utilised to generate new Hidden Markov Models, the model generation unit 20 processes the electrical signals received from the microphone 7 to generate Hidden Markov Models representative of the signals in a conventional manner. These Hidden Markov Models are then stored within the Hidden Markov Model database 24. When an utterance is to be recognised, the electrical signals received from the microphone 7 are passed to the speech recognition unit 22 which utilises the stored Hidden Markov Models in the database 24 to match an utterance to a word which is subsequently output.

When Hidden Markov Models are being generated and added to the Hidden Markov Model database 24, each time a new Hidden Markov Model is added to the database, the new model is processed against the Hidden Markov Models already stored within the Hidden Markov Model database 24 by a confusability checker 26 to identify whether the newly generated model closely corresponds to a model already stored. If this is the case, this indicates that utterances are likely to be mismatched between the new Hidden Markov Model and the Hidden Markov Model previously stored in the Hidden Markov Model database 24. In this embodiment, if this is found to have occurred, the confusability checker 26 deletes the new Hidden Markov Model from the database 24 and outputs a warning to a user requesting that an alternative word should be used for recording within the Hidden Markov Model database 24.

The processing of the confusability checker 26 will now be described in detail with reference to FIGS. 3, 4 and 5.

FIG. 3 is a schematic illustration of a pair of Hidden Markov Models each of the Hidden Markov Models M₁ M₂ comprises a set of probability density functions. The probability density functions identify areas in the mathematical space defined by features extracted from utterances. As shown in FIG. 3 the probability density functions of the Hidden Markov Model M₁ are illustrated by the thick circles labelled M₁S₁, M₁S₂, M₁S₃ and M₁S₄. The probability density functions for the Hidden Markov Model M₂ are illustrated by the series of thin circles labelled M₂S₁, M₂S₂ and M₂S₃. Additionally, the Hidden Markov Models include a set of transition probabilities identifying the probability of translating from one state represented by a probability density function to another state represented by a density probability function. These are shown by the arrows in FIG. 3.

The probability that an utterance is mismatched to the second model when the utterance actually corresponds to the word represented by the first model is related to the probability density functions for the Hidden Markov Models. Considering only the probability that the first portion of an utterance corresponding to the first state of the first model is mismatched to the first state of the second model may be written as follows:

Equation 1

Probability=E[P2 (x) ]

where E is the expectation of the Probability of a signal x corresponding to the first state M₁S₁ of Model 1 being matched to the first state of M₂S₂ of the second model.

This probability essentially corresponds to the probability of a signal derived from an utterance giving rise to features lying within the shaded area of the area of overlap of the circles labelled M₁S₁ and M₂S₂ shown in FIG. 3.

Where each of the probability density functions of the Hidden Markov Models are represented by Gausians, the probability of equation 1 corresponds to a calculation of:

$$Equation 2 \text{:} = \int \frac{1}{\sqrt{2 {πσ}_{1} {σ}_{2}}} {ⅇ}^{- \frac{1}{2} \frac{{( x - {μ}_{2} )}^{2}}{{σ}_{2}}} {ⅇ}^{- \frac{1}{2} \frac{{( x - {μ}_{1} )}^{2}}{{σ}_{1}}} ⅆ x$$

where x is the signal, σ₁ is the variance of the probability density function of the first state M₁S₁ Model 1, σ₂ is the variance of the probability density function of the first state M₂S₁ Model 2 and μ₁ and μ₂ are the mean values of the probability functions of the first state of Model 1 and Model 2 respectively.

Equation 2 can be determined as being equal to:

$$Equation 3 \text{:} = \sqrt{\frac{2 {πσ}_{1} {σ}_{2}}{{σ}_{1} + {σ}_{2}}} [ {ⅇ}^{- \frac{1}{2} \frac{{( {μ}_{1} - {μ}_{2} )}^{2}}{{σ}_{1} - {σ}_{2}}} ]$$

Ignoring the first term which is dependent solely upon the variances of the probability density functions which may be ignored if these values are approximately constant, a value proportional to the probability may be calculated using the exponential term being equal to:

$$Equation 4 \text{:} {ⅇ}^{- \frac{1}{2} \frac{{( {μ}_{1} - {μ}_{2} )}^{2}}{{σ}_{1} + {σ}_{2}}}$$

These values can then be calculated for all the combinations of states of the two models using only the probability density functions for the Hidden Markov Models. Thus in this way for each state of each model a value proportional to the probability of a portion of a signal being mismatched can be determined.

In order for a single value of the probability of an utterance represented by one of the Hidden Markov Models being mismatched to the other Hidden Markov Model to be determined these calculated values are then processed as will now be described in detail with reference to FIGS. 4 and 5.

Initially (S1) the confusability checker 26 retrieves the probability density functions of the Hidden Markov Models within the Hidden Markov Models database 24 which are being compared from the Hidden Markov Models database 24. The confusability checker 26 then (S2) calculates for first state of the first model values of the following

$$Equation 5 \text{:} ln [ {ⅇ}^{- \frac{1}{2} \frac{{( {μ}_{1 i} - {μ}_{2 j} )}^{2}}{( {σ}_{1 i} + {σ}_{2 j} )}} ]$$

FIG. 5 is an illustration of a table generated by the confusability checker 26 for the pair of Hidden Markov Models illustrated in FIG. 3. Initially the confusability checker 26 calculates Equation 5 to obtain a value indicative of the confusion between the first state of the first model M₁S₁ and the first state M₂S₁ of the second model. This value is then recorded in the table. In FIG. 5 this is illustrated by the number −10 appearing in the top left hand corner of the table of FIG. 5.

The confusability checker 26 then calculates Equation 5 for the confusability between the first state of the first model M₁S₁ and the second state M₂S₂ of the second model. In this embodiment where the only allowable transition to the second state of the second model M₂S₂ is from the first state of the second model M₂S₁, this value is then added to previously the calculated value for the confusion between the first state of the first model M₁S₁ and the first state of the second model M₂S₁ and the sum is stored as a confusability value. In FIG. 5 this is shown as the value −1,000 in the first line of the central column of FIG. 5.

The confusability checker 26 then calculates Equation 5 for the confusion between the first state of the first model M₁S₁ and the final state M₂S₃ of the second model. A value comprising the sum of this value and the values for the confusability values previously calculated are then stored. Specifically the confusability checker determines the following sum:

$$Equation 6 \text{:} f ( {M}_{1} {S}_{1} {M}_{2} {S}_{1} ) + f ( {M}_{1} {S}_{1} {M}_{2} {S}_{2} ) + f ( {M}_{1} {S}_{1} {M}_{2} {S}_{3} )$$

$$where$$

$$f ( {M}_{1} {S}_{i} {M}_{2} {S}_{j} ) = ln [ {ⅇ}^{- \frac{1}{2} \frac{{( {μ}_{1 i} - {μ}_{2 j} )}^{2}}{( {σ}_{1 i} + {σ}_{2 j} )}} ]$$

Returning to FIG. 4, when values have been calculated for the first row of the table of FIG. 5, the confusability checker 26 then (S3) determines whether confusability values have been stored for all of the states of the first model. If this is not the case, the confusability checker 26 then calculates Equation 5 for the next state of the first model compared with the first state M₂S₁ of the M₁S₁ second model. This figure is then added to the value calculated for the confusability between the first state of the first model M₁S₁ and the first state of the second model M₂S₂. This sum is then stored together with data identifying the value as having been calculated utilising the transition from the first state of the first model to the second state of the first model. This value is shown in FIG. 5 as the value of −40 in the second row of the table of FIG. 5 together with the arrow pointing from the figure of −40 to the figure of −10 in the first row of the table of FIG. 5.

The confusability checker 26 then calculates a value for the confusability between the second state M₁S₂ of the first model and the second state M₂S₂ of the second model and adds this to the lowest sum of figures for allowable transitions from an initial match between the first state of the first model and the first state of the second model.

In the case of a Hidden Markov Model only allowing self-replication and forward-replication the figure for this match will be determined as being the least of the three possible transformations representing the matches between the following states:

M₁S₁M₂S₁→M₁S₂M₂S₂

M₁S₁M₂S₁→M₁S₁M₂S₂→M₁S₂M₂S₂

M₁S₁M₂S₁→M₁S₂M₂S₁→M₁S₂M₂S₁.

In the case of Table 5 as the values for the transitions

M₁S₁M₂S₁→M₁S₁M₂S₁

M₁S₁M₂S₁→M₁S₁M₂S₂

M₁S₁M₂S₁→M₁S₂M₂S₁

are −10, −40 and −1000, the least value would be derived from the sum of the values for Equation 5 for the matches between M₁S₁M₂S₁ and M₁S₂M₂S₂. This is then shown as a value of −55 in the table of FIG. 5 together with a diagonal arrow indicating that the figure is derived utilising the earlier figure of −10 for the match between M₁S₁ and M₂S₁.

A similar process is then undertaken to determine a value for Equation 5 for the match between the second state of the first model M₁S₂ with the third state M₂S₃ of the second model and then calculating the sum of this value with the least calculated value for an earlier allowable state from which the match of M₁S₂M₂S₃ can be made. Processing is then repeated for each of the subsequent states of the first model until the table is completed. More generally, for each entry in the table the following value is calculated:

$$Equation 7 \text{:}$$

$$cv ( 1 , 1 ) = f ( {M}_{1} {S}_{1} {M}_{2} {S}_{2} )$$

$$cv ( i , j ) = f ( {M}_{1} {S}_{i} {M}_{2} {S}_{j} ) + min [ cv ( k , l ) ]$$

$$where$$

$$f ( {M}_{1} {S}_{i} {M}_{2} {S}_{j} ) = ln [ {ⅇ}^{- \frac{1}{2} \frac{{( {μ}_{1 i} - {μ}_{2 j} )}^{2}}{( {σ}_{1 i} + {σ}_{2 j} )}} ]$$

and k and l are values such that the transition probabilities for the transitions M_{1 k→M}₁ᵢ and M₂ₗ→M₂ⱼare greater than zero.

The values for cv for each state can be determined in an efficient manner utilising conventional dynamic programming techniques.

When confusability techniques have been calculated for all the cells in the table (S3) the confusability checker 26 then identifies the path utilised to derive the figure in the bottom right hand corner of the table which in FIG. 5 is shown as the value of −70. The path used to derive this figure is then identified from the stored path data which in the case of FIG. 5 identifies the path

M₁S₄M₂S₃→M₁S₃M₂S₂→M₁S₂M₂S₁→M₁S₁M₂S₁.

The number of steps in this path is then determined (S6) by the confusability checker 26 which then (S7) outputs as a value indicative of the confusability of the two models the figure for the confusability of the final pair of states in the table divided by the number of steps in the path utilised to calculate that figure. Thus in this example the value of −70/4 would be output. If it is determined that the value is indicative of too high a degree of confusability, the proposed latest condition to the Hidden Markov Models database is then deleted and a user prompted to enter an alternative word.

### Further Modifications

Although in the above embodiment words are described as being automatically rejected if they are determined to be too similar an alternative system could cause Models for words to be stored but deactivated from being utilised if they were too similar. When the confusable words were later deleted from the database 24 or deactivated the recognition unit 22 could then be enabled to utilise the previously deactivated words.

Although in the above embodiment a confusability value is described as being derived solely from the probability density functions for a hidden Markov model the transition probability would also be utilised. In such a system values for confusion for a pair of models could be generated utilising a modified version of equation 7 as follows

$$Equation 8 \text{:}$$

$$\begin{matrix}cv ( 1 , 1 ) = f ( {M}_{1} {S}_{1} {M}_{2} {S}_{1} ) \\ cv ( i , j ) = f ( {M}_{1} {S}_{i} {M}_{2} {S}_{j} ) + \\ min [ cv ( k , 1 ) + t ( {M}_{1 k} \to {M}_{1 i} ) + t ( {M}_{2 l} \to {M}_{2 j} ) ] \\ where \\ f ( {M}_{1} {S}_{i} {M}_{2} {S}_{j} ) = ln [ {ⅇ}^{- \frac{1}{2} \frac{{( {μ}_{1 j} - {μ}_{2 j} )}^{2}}{( {σ}_{1 j} + {σ}_{2 j} )}} ]\end{matrix}$$

and t(M₁ₖ→M₁ᵢ) and t(M₂ₗ→M₂ⱼ) are logarithmic transition probabilities for the transitions from state k to state i in Model 1 and state 1 state j in Model 2 respectively.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. An apparatus for measuring the likelihood that a series of signals corresponding to a first hidden Markov model will be identified with a second hidden Markov model using a data store configured to store a plurality of hidden Markov models, said models each comprising data identifying a series of probability density functions for a number of states, said apparatus comprising:
a calculator operable to calculate for each of the probability density functions of a first stored model stored in said data store values indicative of the logarithmic probability of a signal corresponding to a state identified by said stored probability density function would be identified with the states identified by probability density functions of a second stored model stored in said data store;
a determinator operable to determine from values calculated by said calculator, a set of transitions between said states of said first and second models stored in said data store where the states are associated with values indicative of the highest probabilities of signals corresponding to states of said first stored model being identified with states of said second stored model; and
an output unit operable to output as a measure of the likelihood of a series of signals corresponding to said first stored model being identified with said second stored model, the sum of calculated values for said set of transitions divided by the number of steps in said set of transitions.

2. Apparatus in accordance with claim 1, wherein said data store is configured to store models comprising data identifying a series of probability density functions for a set of states including a first state and a last state wherein said determinator is operable to determine a set of transitions from said first states of said models to said last states of said models associated with values indicative of the highest probabilities of signals corresponding to states of said first stored model being associated with said second stored model.

3. Apparatus in accordance with claim 2, wherein said data store is configured to store models comprising data identifying an allowable set of transitions within said series of states wherein said determinator is operable to determine the set of allowable transitions between states of said models associated with values indicative of the highest probabilities of signals corresponding to states of said first model being identified with said second model.

4. Apparatus in accordance with claim 3, wherein said data store is configured to store models comprising transition probability data associated with each of said allowable transitions, wherein said determinator is operable to determine a set of transitions associated with the highest probabilities of signals corresponding to states of said first model will occur and be matched to states in said second model utilizing a determined probability of said set of transitions occurring determined from said transition probabilities and wherein said measure of the likelihood of signals corresponding to said first model being identified with said second model comprises the sum of values for said set of transitions and logarithmic transition probabilities for said set of transitions divided by the number of steps in said set of transitions.

5. Apparatus in accordance with claim 1, wherein said data store is configured to store models each comprising data identifying a series of probability density functions corresponding to Gausian functions identified by a mean value and a variance wherein said calculator is operable to calculate said values for pairs of states from a said first and a said second models by determining
$$ln [ exp ( 0.5 * \frac{{( {μ}_{1} - {μ}_{2} )}^{2}}{{σ}_{1} + {σ}_{2}} ) ]$$
where μ₁ and σ₁ are the mean and variance of a probability density function from said first stored model and μ₂ and σ₂ are the mean and variance of a probability density function from said second stored model.

6. Apparatus in accordance with claim 5, wherein said determinator is operable to determine for pairs of probability density functions from a said first and second stored models a value CVᵢⱼ where
CVᵢⱼ=valueᵢⱼ for i=1 j=1
CVᵢⱼ=valueᵢⱼ+min (CVₖ₁) for i≠1 j≠1
where valueᵢⱼ is the logarithmic probability of a signal corresponding to state i of said first model is identified with state j of said second model calculated by said calculator and k→i and l→j are allowable transitions between states in said first and second model respectively.

7. Apparatus in accordance with claim 6, wherein said calculator is operable to calculate values corresponding to the sum of said calculated values for the logarithmic probability of a signal corresponding to state i of said first model is identified with state j of said second model and the logarithmic transition probability for the transitions from state k to state i of said first model and state l to state j of said second model.

8. Apparatus in accordance with claim 1, wherein said determinator is operable to determine said set of transitions by determining values utilizing dynamic programming.

9. A method of obtaining a measure of the likelihood that a series of signals corresponding to a first hidden Markov model will be identified with a second hidden Markov model, said models each comprising data identifying a series of probability density functions for a number of states, said method comprising:
calculating for each of said probability density functions of said first model values indicative of the logarithmic probability of a signal corresponding to a state identified by said probability density function would be identified with the states identified by said probability density functions of said second model;
determining from said calculated values a set of transitions between said states of said models where said states are associated with values indicative of the highest probabilities of signals corresponding to states of said first model being identified with states in said second model; and
outputting as a measure of the likelihood of a series of signals corresponding to said first hidden Markov model being identified with said second hidden Markov model, the sum of calculated values for said set of transitions divided by the number of steps in said set of transitions.

10. A method in accordance with claim 9, wherein each of said first and said second hidden Markov models comprise data identifying a series of probability density functions for a set of states including a first state and a last state wherein said determination of said set of transitions comprises determining a set of transitions from said first states of said models to said last states of said models.

11. A method in accordance with claim 10, wherein said first and said second hidden Markov models further comprise data identifying an allowable set of transitions within said series of states wherein said determination of a set of transitions comprises the determination of the set of allowable transitions between states of said models associated with values indicative of the highest probabilities of signals corresponding to states of said first model being identified with said second model.

12. A method in accordance with claim 11, wherein said first and said second hidden Markov models further comprise transition probability data associated with each of said allowable transitions, wherein said determination step comprises determining a set of transitions associated with the highest probabilities of signals corresponding to states of said first model will occur and be matched to states in said second model utilizing a determined probability of said set of transitions occurring determined from said transition probabilities and wherein said measure of the likelihood of signals corresponding to said first model being identified with said second model comprises the sum of values for said set of transitions and logarithmic transition probabilities for said set of transitions divided by the number of steps in said set of transitions.

13. A method in accordance with claim 9, wherein said first and second hidden Markov models each comprise data identifying a series of probability density functions corresponding to Gausian functions identified by a mean value and a variance wherein said calculation of said values for states of said first and said second models comprises a determination of
$$ln [ exp ( 0.5 * \frac{{( {μ}_{1} - {μ}_{2} )}^{2}}{{σ}_{1} + {σ}_{2}} ) ]$$
where μ₁ and σ₁ are the mean and variance of a probability density function from said first model and μ₂ and σ₂ are the mean and variance of a probability density function from said second model.

14. A method in accordance with claim 13, wherein said determination of the set of transitions between probability density functions comprises determining for pairs of probability density functions from said first and second models a value CVᵢⱼ where
Cvᵢⱼ=valueᵢⱼ for i=1 j=1
CVᵢⱼ=valueᵢⱼ+min (CVₖₗ) for i≠1 j≠1
where valueᵢⱼ is said calculated value for the logarithmic probability of a signal corresponding to state i of said first model is identified with state j of said second model and k→i and l→j are allowable transitions between states in said first and second model respectively.

15. A method in accordance with claim 14, wherein valueᵢⱼ is the sum of said calculated value for the logarithmic probability of a signal corresponding to state i of said first model is identified with states of said second model and the logarithmic transition probability for the transitions k→i and l→j.

16. A method in accordance with any of claim 9, wherein said determination of said set of transitions comprises determining values utilizing dynamic programming.

17. A recording medium, storing computer implementable processor steps for causing a programmable computer to perform a method in accordance with claim 9.

18. A recording medium in accordance with claim 17 comprising a computer disc.

19. A recording medium in accordance with claim 17 comprising an electric signal transferred via the Internet.

20. A computer disc in accordance with claim 19, wherein said computer disc comprises an optical, magneto-optical or magnetic disc.
